(19) United States
(12) Patent Application Publication
(10) Pub. No.: US 2012/0006353 A1
(43) Pub. Date: Jan. 12, 2012

(54) JEV SYSTEMS

(76) Inventor: Jason Readinger, Sinking Spring, PA (US)

(21) Appl. No.: 13/171,227

(22) Filed: Jun. 28, 2011

Related U.S. Application Data
(60) Provisional application No. 61/361,949, filed on Jul. 7, 2010.

(51) Int. Cl. A47L 23/04; B08B 1/00

(52) U.S. Cl. 134/6; 15/236.08

(57) ABSTRACT

A footwear cleaning tool comprising a pick and/or a pry bar suitable to clean the athletic shoes. The footwear cleaning tool further comprises a shank having a proximate end and a distal end. Further, the footwear cleaning tool is manipulatable using one hand and comprises plastic. The footwear cleaning tool is designed to remove debris such as mud, grass, and/or sand from a bottom of athletic shoes such as cleats to increase traction of the athletic shoes. The proximate end comprising a T-handle and is knurled while the distal end is angled at approximately 70 degrees in relation to the proximate end. The distal end comprising a toothed engager further comprising a cloven profile. The toothed engager of the footwear cleaning tool is useful for pry-removing and/or scrape-removing the debris from between the cleats.

### CROSS-REFERENCE TO RELATED APPLICATION

The present application is related to and claims priority from prior provisional application Ser. No. 61/361,949, filed Jul. 7, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of cleat cleaners and more specifically relates to a novel cleat cleaning tool.

2. Description of the Related Art

Many competitive sports in modern societies are performed outdoors on grassy or dirt surfaces which may cause the athlete to slip or slide because of the speed and directional changes required across the surfaces of loose materials. Cleat shoes are designed to prevent slippage while playing sports and to give the athlete every advantage in speed and maneuverability. Therefore, a significant amount of outdoor sports, such as soccer or football, require players to wear athletic cleats.

Cleats are protrusions or studs attached to the bottom of the sports shoe that can be replaceable using a tool to remove the worn cleats, or permanently molded into the outer sole of the shoe. Depending on the type of surface, kind of sport, and even the wearer's position or role in the game, different cuts of boot and particularly stud arrangements are available. For hard fields, amateur participants may wear a sneaker shoe or a plastic-stud boot (known as a “molded sole”). In most sports and positions this is adequate, although on a well-grassed or sodden field, a screw stud is recommended for more grip; these may be metal, rubber or plastic.

Cleat shoes are designed with a particular type of surface in mind. After running or moving around for an extended period of time, the spaces in between the teeth on the cleats become filled with mud, grass, sand, and the like. This can cause the footwear to feel heavy and sluggish to the wearer. This condition may also diminish traction, which is vital in any sport. Removing this debris can be a difficult and time-consuming task. Most individuals attempt to dislodge it by striking the shoes off of a hard surface, which can damage the footwear.

Various attempts have been made to solve the above-mentioned problems such as those found in U.S. Pat. Nos. 5,694,660; 5,509,167; 2006/0101599; 4,670,932; D293,164; and 2,817,863. This prior art is representative of cleat cleaners. None of the above inventions and patents, taken either singly or in combination, is seen to describe the invention as claimed.

Ideally, a cleat cleaner should be user-friendly and, yet would operate reliably and be manufactured at a modest expense. Thus, a need exists for a reliable JEV system to remove grass, mud, and other debris from in between the teeth of athletic cleats, sneakers, or any other type of athletic shoe (or other footwear) and to avoid the above-mentioned problems.

### BRIEF SUMMARY OF THE INVENTION

In view of the foregoing disadvantages inherent in the known cleat cleaning art, the present invention provides a novel JEV system. The general purpose of the present invention, which will be described subsequently in greater detail is to provide a handheld tool designed to remove grass, mud, and other debris from in between the teeth of athletic cleats, sneakers, or any other type of athletic shoe. By removing the debris, players are afforded improved traction and a lighter ‘feel’. This small tool may be easily stored in an athletic bag.

The present invention, JEV system, as disclosed herein, preferably comprises: a footwear cleaning tool. The footwear cleaning tool comprises a pick and/or a pry bar suitable to clean the athletic shoes. The footwear cleaning tool further comprises a shank having a proximate end and a distal end. Further, the footwear cleaning tool is manipulatable using one hand and comprises plastic or other suitable material. The footwear cleaning tool is designed to remove debris such as mud, grass, and/or sand from a bottom of athletic shoes such as cleats to increase traction of the athletic shoes.

The proximate end comprises a T-handle and is knurled while the distal end is angled at approximately 70 degrees in relation to the proximate end. The distal end comprising a toothed engager further comprising a cloven profile. The toothed engager of the footwear cleaning tool is useful for pry-removing and/or scrape-removing the debris from between the cleats.

The cloven profile of the toothed engager comprises an inclined V-shape. Additionally, the toothed engager comprises tips and a base. The tips of the toothed engager comprise rounded edges in preferred embodiments while the base of the toothed engager comprises an arc-contour. The arc-contour of the base defines a cleat skirting recess such that the toothed engager may be circularly-manipulated around the cleats.

In accordance with the embodiments of the present invention a preferred method of use is disclosed herein comprising: step one lifting a footwear item; and step two manipulating the footwear cleaning tool to remove debris from a bottom (side/surface) of the footwear. The footwear comprises an athletic shoe with at least one cleat. The footwear cleaning tool may be manipulated around the at least one cleat. Further, the footwear may comprise a boot with a gripping surface, wherein the footwear cleaning tool is used as a scraping and/or picking device to clean the gripping surface.

The present invention holds significant improvements and serves as a JEV system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, JEV systems, constructed and operative according to the teachings of the present invention.

FIG. 1 shows a perspective view illustrating JEV systems in an ‘in-use’ condition according to an embodiment of the present invention.

FIG. 2 shows a perspective view illustrating a footwear cleaning tool of the JEV systems according to an embodiment of the present invention.

FIG. 3 shows another perspective view illustrating the footwear cleaning tool of the JEV systems to an embodiment of the present invention.

FIG. 4 is a flowchart illustrating a method of use for the footwear cleaning tool of the JEV systems according to an embodiment of the present invention of FIGS. 1-3.

The various embodiments of the present invention will hereinafter be described in conjunction with the appended drawings, wherein like designations denote like elements.

### DETAILED DESCRIPTION

As discussed above, embodiments of the present invention relate to a cleat cleaning device and more particularly to JEV system 100 to remove grass, mud, and other debris from in between the teeth of athletic cleats, sneakers, and virtually any other type of athletic shoe and/or gripped footwear.

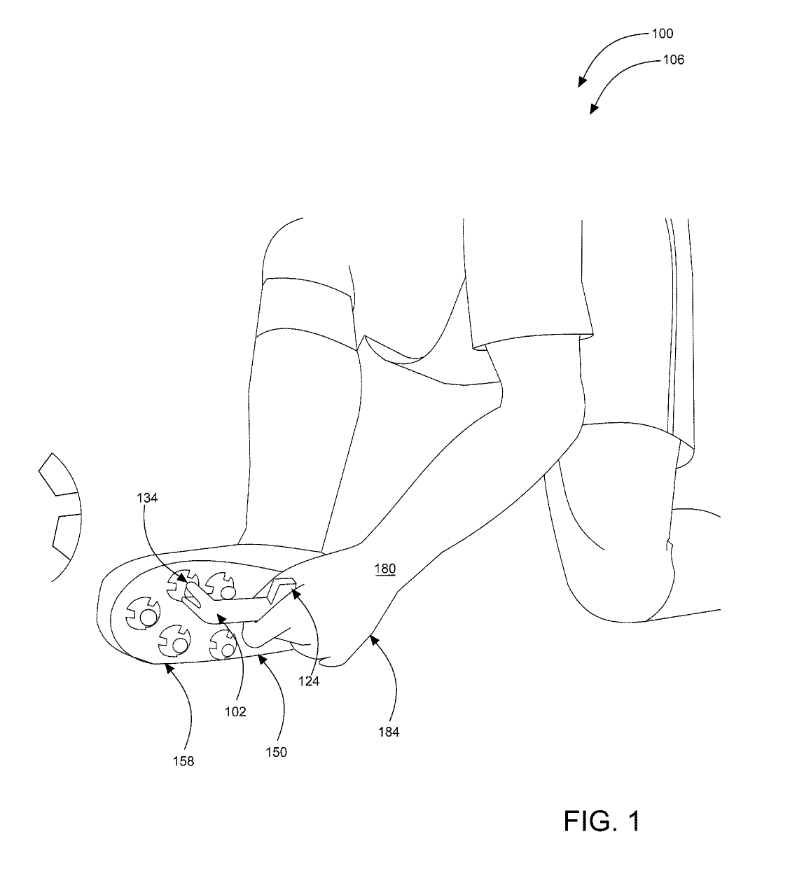

Referring now to FIG. 1 showing a perspective view of JEV systems 100 in ‘in-use’ condition 106 according to an embodiment of the present invention. JEV systems 100 preferably comprises footwear cleaning tool 102. Footwear cleaning tool 102 includes a handheld tool designed to remove debris from in between cleats located on bottom portion 158 of footwear 150. Footwear 150 may include but is not limited to athletic cleats, sneakers, boots or any other type of athletic shoe. Further, debris may comprise but is not limited to mud, grass, and sand.

By removing unwanted debris accumulated on footwear 150 as shown in ‘in-use’ condition 106, athlete(s) 180 may be afforded improved traction and a lighter ‘feel’ when running, jumping, or moving on an even or uneven surface. Footwear cleaning tool 102 is portable due to the compact size of footwear cleaning tool 102 and may be easily stored in an athletic bag, providing user convenience. Also, due to the design and size footwear cleaning tool 102, footwear cleaning tool 102 may be manipulatable by athlete(s) 180 using only one hand such as by using only a forefinger and thumb. However, if athlete(s) 180 so chooses, he/she may use all of his/her fingers.

Additionally, footwear cleaning tool 102 may assist in preventing mud and dirt from being tracked into residents or businesses. This removal of unwanted debris may be appreciated by homeowners and business owners accumulated in between teeth (cleats) on bottom portion 158 of footwear 150 prior to entering into an inside dwelling. The decrease in the amount of debris tracked into an inside dwelling may decrease the need for cleaning up debris that has been discarded off of footwear 150.

Footwear cleaning tool 102 preferably comprises plastic and may be manufactured in a wide array of colors and designs per preference of athlete(s) 180. Upon reading this specification, it should be appreciated that, under appropriate circumstances, considering such issues as user preferences, design preference, structural requirements, marketing preferences, cost, available materials, technological advances, etc., other materials such as, for example, rubber, metal, etc., may be sufficient.

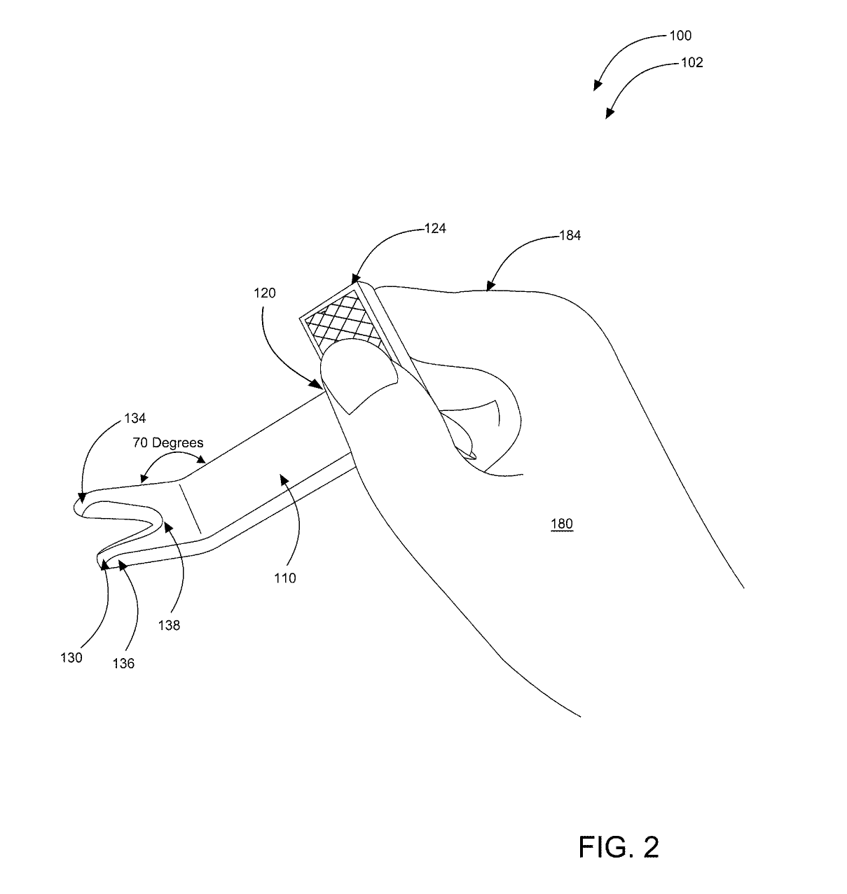

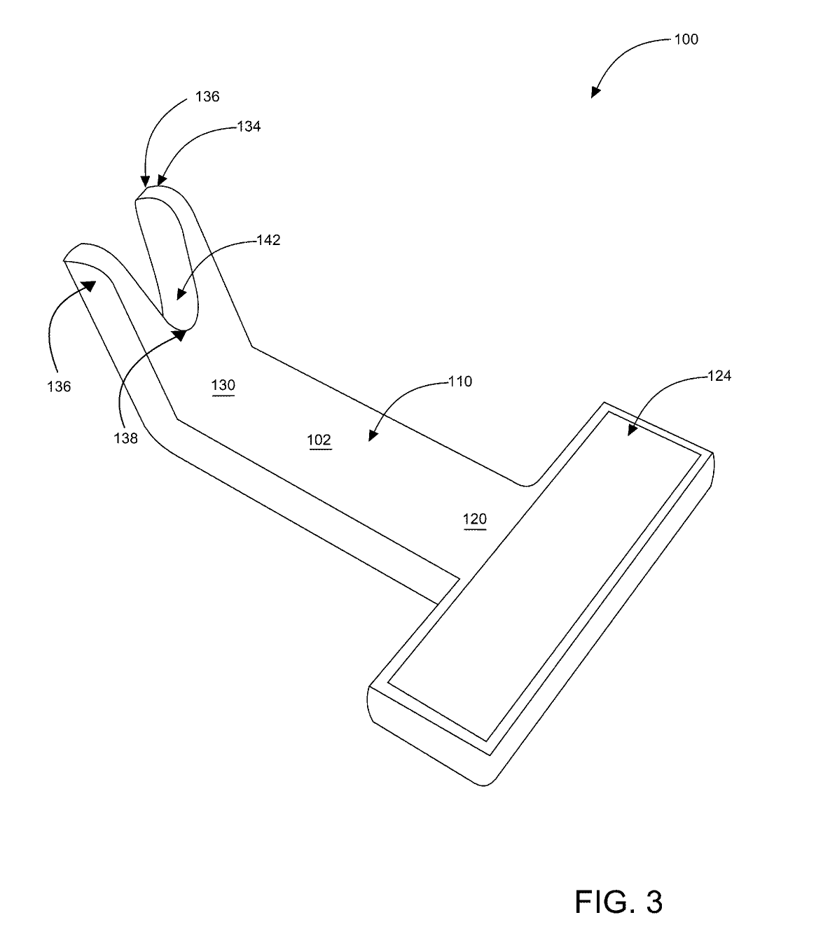

Referring now to FIGS. 2 and 3 showing perspective views of footwear cleaning tool 102 of JEV systems 100 according to an embodiment of the present invention. Footwear cleaning tool 102 preferably comprises shank 110 having proximate end 120 and distal end 130. Footwear cleaning tool 102 may comprise a pick or a pry bar. Proximate end 120 of footwear cleaning tool 102 preferably comprising a T-handle 124 while distal end 130 of footwear cleaning tool 102 preferably comprises toothed engager 134, as shown best in FIG. 2. T-handle 124 may further comprise contoured-surface 126 to increase gripping by hand 184 of athlete(s) 180 when using footwear cleaning tool 102. Additionally, contoured-surface 126 may comprise rubber to decrease slippage of footwear cleaning tool 102 out of hand 184 of athlete(s) 180 when ‘in-use’ condition 106. Toothed engager 134 of footwear cleaning tool 102 may be useful for pry-removing and scrape-removing the unwanted accumulated debris from between cleats on footwear 150.

As shown best in FIG. 2, distal end 130 of footwear cleaning tool 102 is preferably angled at approximately 70 degrees in relation to proximate end 120 of footwear cleaning tool 102 to provide a comfortable angle for engaging toothed engager 134 in relation to cleats on footwear 150 when using footwear cleaning tool 102.

Toothed engager 134 of footwear cleaning tool 102 preferably comprises a cloven profile (split, bifruated, or divided in two) or inverted V-shape. Further, toothed engager 134 may comprise tips 136 and a base 138 along with rounded edges 140 to aid in the more direct and accurate cleaning of cleats on footwear 150 when using footwear cleaning tool 102. Toothed engager 134 may also comprise arc-contour 142. Arc-contour 142 on base 138 preferably defines a cleat skirting recess such that toothed engager 134 may be circularly-manipulated around cleats with relative ease and accuracy.

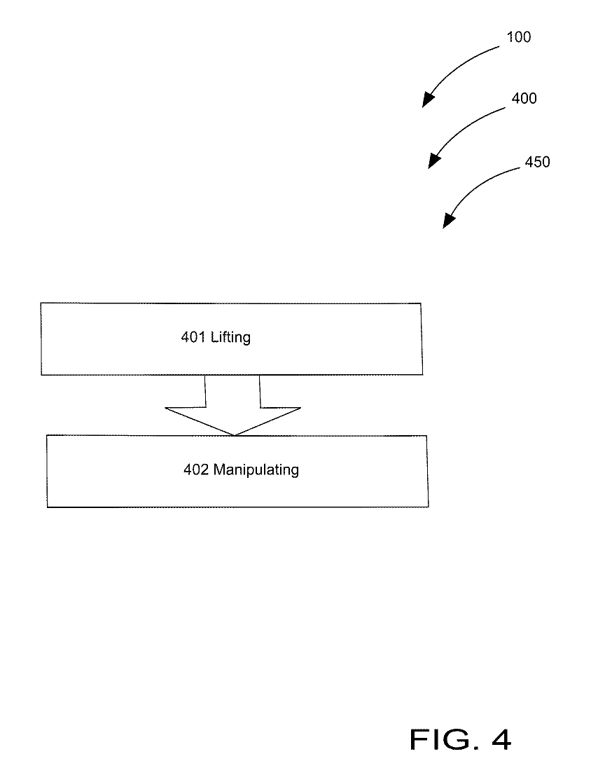

FIG. 4. shows flowchart 450 illustrating method of use 400 according to an embodiment of the present invention of FIGS. 1-3. A method of using (at least herein enabling method of use 400) JEV systems 100 may comprise the steps of: step one 401 lifting a footwear item; and step two 402 manipulating footwear cleaning tool 102 to remove debris from bottom portion 158 of footwear 150. Footwear 150 preferably comprises an athletic shoe with at least one cleat, wherein footwear cleaning tool 102 may be manipulated around at least one cleat. Further, footwear 150 may comprise a boot with a gripping surface, wherein footwear cleaning tool 102 is used as a scraping and/or picking device to clean the gripping surface.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A footwear cleaning tool comprising:
a shank having a proximate end and a distal end,
said proximate end comprising a T-handle,
said distal end comprising a toothed engager, and
wherein said footwear cleaning tool is designed to remove debris from a bottom of athletic shoes to increase traction of said athletic shoes.

2. The footwear cleaning tool of claim 1 wherein said athletic shoes comprise cleats, said toothed engager of said footwear cleaning tool is useful for pry-removing said debris from between said cleats.

3. The footwear cleaning tool of claim 1 wherein said athletic shoes comprise cleats, said toothed engager of said footwear cleaning tool is useful for scrape-removing said debris from between said cleats.

4. The footwear cleaning tool of claim 1 wherein the debris comprises mud, grass, and sand.

5. The footwear cleaning tool of claim 1 wherein said distal end is angled at approximately 70 degrees in relation to said proximate end.

6. The footwear cleaning tool of claim 1 wherein said proximate end is knurled.

7. The footwear cleaning tool of claim 1 wherein said footwear cleaning tool is manipulatable using one hand.

8. The footwear cleaning tool of claim 1 wherein said footwear cleaning tool comprises plastic.

9. The footwear cleaning tool of claim 2 wherein said toothed engager comprises a cloven profile.

10. The footwear cleaning tool of claim 9 wherein said cloven profile of said toothed engager comprises an inverted V-shape.

11. The footwear cleaning tool of claim 10 wherein said toothed engager comprises tips and a base.

12. The footwear cleaning tool of claim 11 wherein said tips of said toothed engager comprise rounded edges.

13. The footwear cleaning tool of claim 11 wherein said base of said toothed engager comprises an arc-contour.

14. The footwear cleaning tool of claim 13 wherein said arc-contour of said base defines a cleat skirting recess such that said toothed engager may be circularly-manipulated around said cleats.

15. The footwear cleaning tool of claim 1 wherein said footwear cleaning tool comprises a pick.

16. The footwear cleaning tool of claim 1 wherein said footwear cleaning tool comprises a pry bar.

17. A footwear cleaning tool comprising:
a shank having a proximate end and a distal end,
said proximate end comprising a T-handle,
said distal end comprising a toothed engager,
wherein said distal end is angled at approximately 70 degrees in relation to said proximate end;
wherein said proximate end is knurled;
wherein said footwear cleaning tool is manipulatable using one hand;
wherein said footwear cleaning tool comprises plastic;
wherein said footwear cleaning tool is designed to remove debris from a bottom of athletic shoes to increase traction of said athletic shoes;
wherein said debris comprises mud, grass, and/or sand;
wherein said athletic shoes comprise cleats, said toothed engager of said footwear cleaning tool is useful for pry-removing and/or scrape-removing said debris from between said cleats;
wherein said toothed engager comprises a cloven profile;
wherein said cloven profile of said toothed engager comprises an inclined V-shape;
wherein said toothed engager comprises tips and a base;
wherein said tips of said toothed engager comprise rounded edges;
wherein said base of said toothed engager comprises an arc-contour;
wherein said arc-contour of said base defines a cleat skirting recess such that said toothed engager may be circularly-manipulated around said cleats; and
wherein said footwear cleaning tool comprises a pick and/or a pry bar suitable to clean said athletic shoes.

18. A method for using a footwear cleaning tool comprising the steps of:
lifting a footwear item; and
manipulating said footwear cleaning tool to remove debris from a bottom of said footwear item.

19. The method for using a footwear cleaning tool of claim 18 wherein said footwear comprises an athletic shoe with at least one cleat, wherein said footwear cleaning tool may be manipulated around said at least one cleat.

20. The method for using a footwear cleaning tool of claim 18 wherein said footwear comprises a boot with a gripping surface, wherein said footwear cleaning tool is used as a scraping and/or picking device to clean said gripping surface.
